(19) United States
(12) Patent Application Publication
(10) Pub. No.: US 2007/0071404 A1
(43) Pub. Date: Mar. 29, 2007

(54) Controlled video event presentation

(75) Inventors: Keith L. Curtner, St. Paul, MN (US); Saad J. Bedros, West St. Paul, MN (US); Wing Kwong Au, Bloomington, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/238,355

(22) Filed: Sep. 29, 2005

(51) Int. Cl. H04N 7/00

(52) U.S. Cl. 386/95

(57) ABSTRACT

The present invention pertains to video playback systems, devices and methods for searching events contained within a video image sequence. A video playback system in accordance with an illustrative embodiment of the present invention includes a video playback device adapted to run a sequential searching algorithm for sequentially presenting video images within an image sequence, and a user interface that can be used by an operator to detect the occurrence of an event contained within the image sequence. Methods of searching for an event of interest contained within an image sequence are also disclosed herein.

Field

The present invention relates generally to the field of video image processing. More specifically, the present invention pertains to video playback systems, devices, and methods for searching events contained within a video image sequence.

### BACKGROUND

Video surveillance systems are used in a variety of applications for monitoring objects within an environment. In outdoor security applications, for example, such systems are sometimes employed to track individuals or vehicles entering or leaving a building facility or security gate, or in indoor applications, they are used to monitor individual's activities within a store, office building, hospital, or other such setting where the health and/or safety of the occupants may be of concern. In the aviation industry, for example, such systems have been used to detect the presence of individuals at key locations within an airport such as at a security gate or parking garage.

In certain applications, the video surveillance system may be tasked to record video images for later use in determining the occurrence of a particular event. In forensic investigations, for example, it may be desirable to task one or more video cameras within the video surveillance system to record video images that can be later analyzed to detect the occurrence of an event such as a robbery or theft. Such video images are typically stored as either analog video streams or as digital image data on a hard drive, optical drive, videocassette recorder (VCR), or other suitable storage means.

The detection of events contained within an image sequence is typically accomplished by a human operator manually scanning the entire video stream serially until the desired event is found, or in the alternative, by scanning a candidate sequence believed to contain the desired event. In certain applications, a set of playback controls can be used to fast-forward and/or reverse-view image frames within the image sequence until the desired event is found. If, for example, the video stream contains an actor suspected of passing through a security checkpoint, the operator may use a set of fast-forward or reverse-view buttons to scan through an image sequence frame by frame until the event is found. In some cases, annotation information such as the date, time, and/or camera type may accompany the image sequence, allowing the operator to move to particular locations within the image sequence where an event is suspected.

The process of manually viewing image data using many conventional video playback devices and methods can be time consuming and tedious, particularly in those instances where the event sought is contained in a relatively large image sequence (e.g. a 24 hour surveillance tape) or in multiple such image sequences. In some cases, the tedium of scanning the image data serially can result in operator fatigue, reducing the ability of the operator to detect the event. While more intelligent playback devices may be capable of responding to a user's query by suggesting one or more candidate video sequences, such devices nevertheless require the user to search through these candidate sequences and determine whether the candidate contains the desired event.

### SUMMARY

The present invention pertains to video playback systems, devices, and methods for searching events contained within video image sequence data. A video playback system in accordance with an illustrative embodiment of the present invention may include a video playback device adapted to run a sequential searching algorithm for sequentially presenting video images to an operator, and a user interface for interacting with the video playback device. In certain embodiments, the video playback device can be configured to run a Bifurcation, Pseudo-Random, Golden Section, and/or Fibonacci searching algorithm that presents video images to the operator in a particular manner based on commands received from the user interface. The user interface may include a set of playback controls that can be used by the operator to initialize the sequential searching algorithm as well as perform other searching tasks. A monitor can be configured to display images presented by the video playback device. In some embodiments, the set of playback controls and/or monitor can be provided as part of a graphical user interface (GUI).

An illustrative method of searching for an event of interest contained within an image sequence may comprise the steps of receiving an image sequence including one or more image frames containing an event of interest, sequentially dividing the image sequence into a number of image sub-sequences, presenting a viewing frame to an operator containing one of the image sub-sequences, prompting the operator to select whether the event of interest is contained within the image sub-sequence, calculating a start location of the next viewing sub-sequence and repeating the steps of sequentially dividing the image sequence into image sub-sequences, and then outputting an image sub-sequence containing the event. In certain embodiments, the step of sequentially dividing the image sequence into image sub-sequences can be performed using a Bifurcation, Pseudo-Random, Golden Section, and/or Fibonacci searching algorithm. Other illustrative methods and algorithms are also described herein.

### BRIEF DESCRIPTION OF THE DRAWINGS

FIG. 1 is a schematic view showing an illustrative video image sequence containing an event of interest;

FIG. 2 is a high-level block diagram showing an illustrative video playback device in accordance with an illustrative embodiment of the present invention;

FIG. 3 is a pictorial view showing an illustrative graphical user interface for use with the illustrative playback device of FIG. 2;

FIG. 4 is a flow chart showing an illustrative method of presenting a video image sequence to an operator using the video playback device of FIG. 2;

FIG. 5A is a schematic view showing an illustrative process of searching an image sequence using a Bifurcation searching algorithm;

FIG. 5B is a schematic view showing an illustrative process of searching an image sequence using a Pseudo-Random searching algorithm;

FIG. 5C is a schematic view showing an illustrative process of searching an image sequence using a Golden Section searching algorithm; and

FIG. 5D is a schematic view showing an illustrative process of searching an image sequence using a Fibonacci searching algorithm.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of algorithms and processes are illustrated for the various elements, those skilled in the art will recognize that many of the examples provided have suitable alternatives that may be utilized.

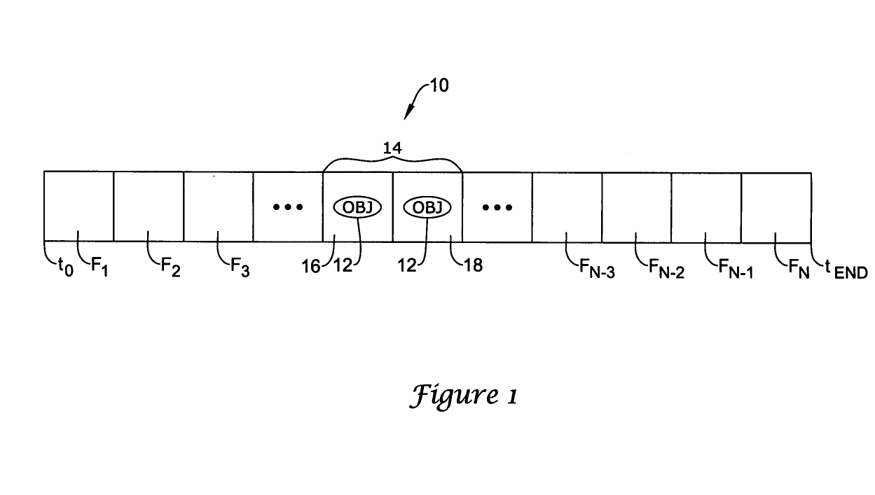

FIG. 1 is a schematic view showing an illustrative video image sequence 10 containing an event of interest. As can be seen in FIG. 1, the image sequence 10 may begin at time t₀ (t=0) with a first image frame F₁, and continuing in ascending order to the right in FIG. 1 with a number of successive image frames F₂, F₃, . . . F_{N-3}, F_{N-2}, F_{N-1}, F_{N} until terminating at time t_{end}. The number of image frames N contained within the image sequence 10 will typically vary depending on the frame capture rate at which the images were acquired as well as the difference in time ΔT (i.e. t_{end}−t₀) between the first image frame F₁ and the last image frame F_{N} within the image sequence. While image frames numbers are used herein as reference units for purposes of describing the illustrative system and methods, it should be understood that other reference units (e.g. seconds, milliseconds, date/time, etc.) could be used in addition to, or in lieu of, image frame numbers in describing the image sequence 10, if desired.

As can be further seen in FIG. 1, one or more image frames within the image sequence 10 may contain an object 12 defining an event 14. In certain embodiments, for example, object 12 may represent an individual detected by a security camera tasked to detect motion within a security checkpoint or other region of interest. The object 12 defining the event 14 may be located in a single image frame of the image sequence 10, or may be located in multiple image frames of the image sequence 10. In the illustrative image sequence 10 of FIG. 1, for example, the object 12 is shown spanning multiple image frames forming an event sequence beginning at frame 16 of the image sequence 10 and ending at frame 18 thereof. While the illustrative event 14 depicted in FIG. 1 is shown spanning two successive image frames, it should be understood that any number of consecutive or nonconsecutive image frames may define an event 14.

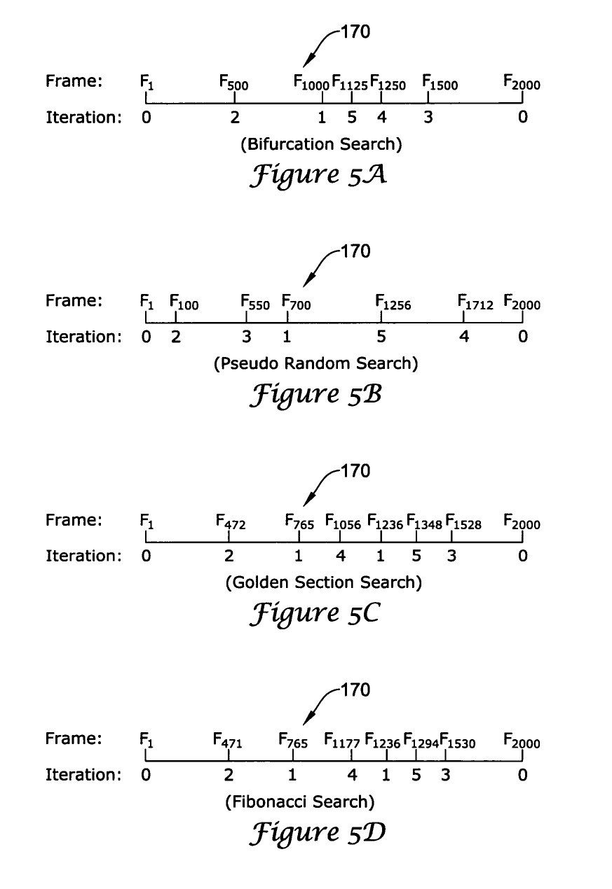

To detect the event 14 within the image sequence 10 using traditional video searching techniques, the operator must typically perform an exhaustive search of the image sequence 10 beginning at time t₀ and continue with each successive image frame within the image sequence 10 until the object 12 triggering the event 14 is detected. In some techniques, and as further described below with respect to the illustrative embodiments of FIGS. 5A-5D, the image sequence 10 can be segmented into image sub-sequences, each of which can be separately viewed by the operator to detect the occurrence of the event 14 within the image sequence 10. In a Bifurcation searching approach, for example, the image sequence 10 can be divided in the middle into two image sub-sequences, which can then each be separately analyzed to detect the occurrence of the event 14 within each individual image sub-sequence.

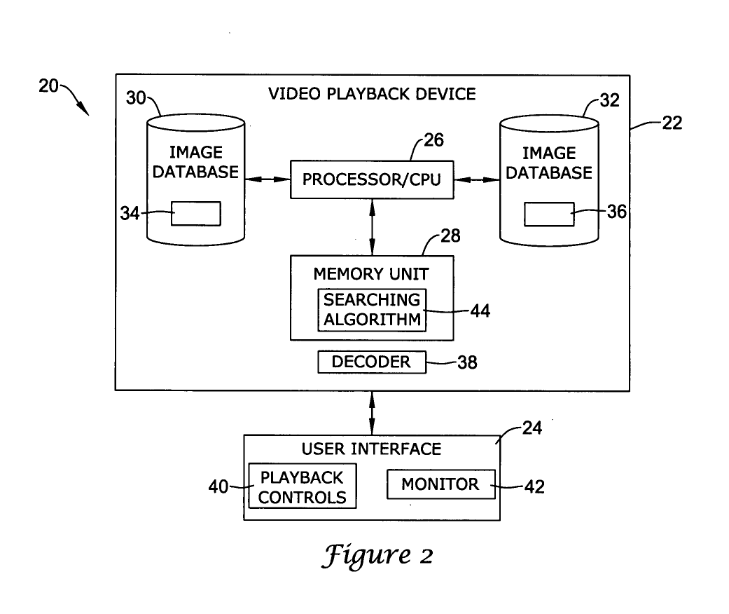

FIG. 2 is a high-level block diagram showing a video playback system 20 in accordance with an illustrative embodiment of the present invention. As shown in FIG. 2, system 20 may include a video playback device 22 adapted to retrieve and process video images, and a user interface 24 that can be used to interact with the video playback device 22 to detect the occurrence of an event within an image sequence. The video playback device 22 may include a processor/CPU 26 that can be tasked to run a number of programs contained within a memory unit 28. In certain embodiments, for example, the memory unit 28 may comprise a ROM chip, a RAM chip or other suitable means for storing programs and/or routines within the video playback device 22.

The video playback device 22 may further include one or more image databases 30,32, each adapted to store an image sequence 34,36 therein that can be subsequently retrieved via the user interface 24 or some other desired device within the system 20. In certain embodiments, for example, the image databases 30,32 may comprise a storage medium such as a hard drive, optical drive, RAM chip, flash drive, or the like. The image sequences 34,36 contained within the image databases 30,32 can be stored as either analog video streams or as digital image data using an image file format such as JPEG, MPEG, MJPEG, etc. The particular image file type will typically vary depending on the type of video camera employed by the video surveillance system. If, for example, a digital video sensor (DVS) is employed, the image sequences will typically comprise a file format such as JPEG, MPEG1, MPEG2, MPEG4, or MJPEG. If desired, a decoder 38 can be provided to convert image data outputted from the video playback device 22 to the user interface 24.

The user interface 24 can be equipped with a set of playback controls 40 to permit the operator to retrieve and subsequently view image data contained within the image databases 30,32. In certain embodiments, for example, the set of playback controls 40 may include a means for playing, pausing, stopping, fast-forwarding, rewinding, and/or reverse-viewing video images presented by the video playback device 22. In some embodiments, the set of playback controls 40 may include a means for replaying a previously viewed image frame within an image sequence and/or a means for playing an image sequence beginning from a particular date, time, or other user-selected location. Such set of playback controls 40 can be implemented using a knob, button, slide mechanism, keyboard, mouse, keypad, touch screen, or other suitable means for inputting commands to the video playback device 22. The images retrieved from the video playback device 22 can then be outputted to a monitor 42 such as a television, CRT, LCD panel, plasma screen, or the like for subsequent viewing by the operator. In certain embodiments, the set of playback controls 40 and monitor 42 can be provided as part of a graphical user interface (GUI) adapted to run on a computer terminal and/or network server.

A searching algorithm 44 contained within the memory unit 28 can be called by the processor/CPU 26 to present images in a particular manner based on commands received from the user interface 24. In certain embodiments, for example, the searching algorithm 44 may be initiated when the operator desires to scan through a relatively long image sequence (e.g. a 24 hour video surveillance clip) without having to scan through the entire image sequence serially until the desired event is found. Invocation of the searching algorithm 44 may occur, for example, by the operator pressing a “begin searching algorithm” button on the set of playback controls 40, causing the processor/CPU 26 to initiate the sequential searching algorithm 44 and retrieve a desired image sequence 34,36 stored within one of the image databases 30,32.

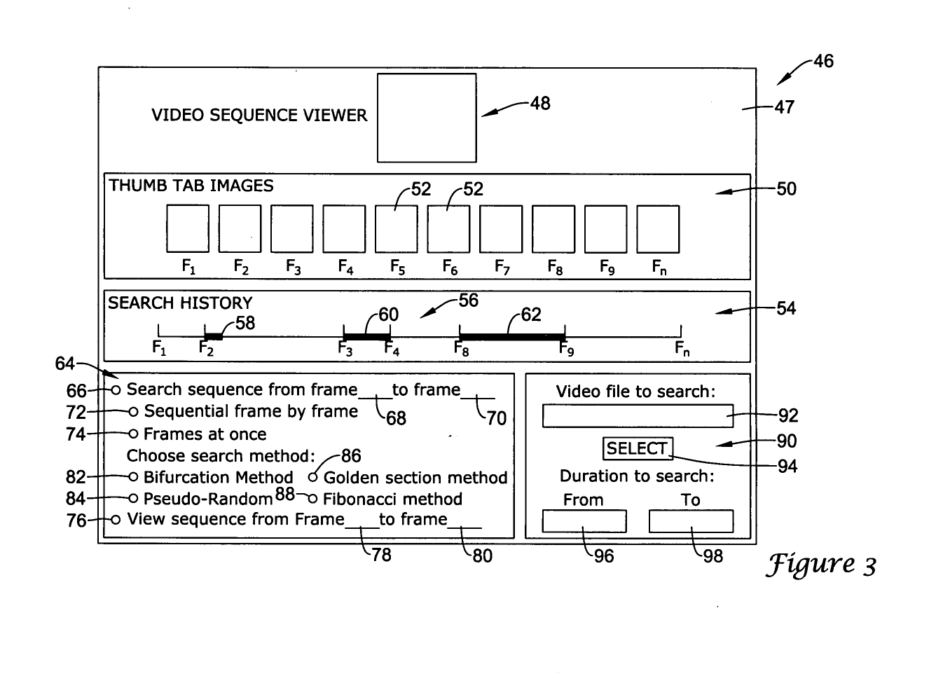

FIG. 3 is a schematic view showing an illustrative graphical user interface (GUI) 46 for use with the illustrative video playback device 22 of FIG. 2. As shown in FIG. 3, the graphical user interface 46 may include a display screen 47 configured to display various information related to the status and operation of the video playback device 22, including any searches that have been previously performed. In the illustrative embodiment of FIG. 3, for example, the graphical user interface 46 can include a VIDEO SEQUENCE VIEWER section 48 that can be used to graphically display the current video image sequence under consideration by the operator. The VIDEO SEQUENCE VIEWER section 48, for example, can be configured to display previously recorded images stored within one or more of the video playback device's 22 image databases 30,32. In some situations, the VIDEO SEQUENCE VIEWER section 48 can be configured to display real-time images that can be stored and later analyzed by the operator using any of the searching algorithms described herein.

A THUMB-TAB IMAGES section 50 of the graphical user interface 46 can be configured to display those image frames forming the video image sequence contained in the VIDEO SEQUENCE VIEWER section 48. The THUMB-TAB IMAGES section 50, for example, may include a number of individual image frames 52 representing various snap-shots or thumbs at distinct intervals during the image sequence. The thumb-tab image frames 52 may be displayed in ascending order based on the frame number and/or time, and may be provided with a label or tag (i.e. “F₁ ”, “F₂”, “F₃”, etc.) that identifies the beginning of each image sub-sequence or image frame. The thumb-tab image frame 52 represented by “F₄” in FIG. 3, for example, may comprise a still image representing a 5-minute video clip of an image sequence having a duration of 2 hours. By selecting the desired thumb-tab image frame 52 on the display screen 47 using a mouse pointer, keyboard, or other suitable selection tool, a video clip corresponding to that selection can be displayed in the VIDEO SEQUENCE VIEWER section 48.

A SEARCH HISTORY section 54 of the graphical user interface 46 can be configured display a time line 56 representing snapshots of those image frames forming the image sequence as well as status bars indicating any image frames that have already been searched. The status bar indicated generally by thickened line 58, for example, may represent a portion of the image sequence from point “F₂” to point “F₃” that has already been viewed by the operator. In similar fashion, a second and third status bar indicated, respectively, by reference numbers 60 and 62, may further indicate that the portions of the image sequence between points “F₃” and “F₄” and points “F₈” and “F₉” have already been viewed. The image sub-sequences that have already been searched may be stored within the video playback device 22 along with the corresponding frame numbers and/or duration. Thereafter, the video playback device 22 can be configured to not present these image sub-sequences again unless specifically requested by the operator.

A SEARCH ALGORITHM section 64 of the graphical user interface 46 can be configured to prompt the user to select which searching algorithm to use in searching the selected image sequence. A SEARCH SELECTION icon button 66 and a set of frame number selection boxes 68,70 may be used to select those image frames comprising the image sequence to be searched. A SEQUENTIAL FRAME BY FRAME icon button 72 and a FRAMES AT ONCE icon button 74, in turn, can be provided to permit the user to toggle between searching image frames sequentially or at once. A VIEW SEQUENCE icon button 76 and a set of frame number selection boxes 78,80 can be used to select those image frames to be displayed within the VIDEO SEQUENCE VIEWER section 48.

The SEARCH ALGORITHM section 64 may further include a number of icon buttons 82,84,86,88 that can be used to toggle between the type of searching algorithm used in searching those image frames selected via the frame number selection boxes 68,70. A BIFURCATION METHOD icon button 82, for example, can be chosen to search the selected image sequence using a Bifurcation searching algorithm, as described below with respect to FIG. 5A. A PSEUDO-RANDOM METHOD icon button 84, in turn, can be chosen to search the selected image frames using a Pseudo-Random searching algorithm, as described with respect to FIG. 5B. A GOLDEN SECTION METHOD icon button 86, in turn, can be chosen to search the selected image sequence using a Golden Section searching algorithm, as described below with respect to FIG. 5C. A FIBONACCI METHOD icon button 88, in turn, can be chosen to search the selected image sequence using a Fibonacci searching algorithm, as described below with respect to FIG. 5D.

The image frames 52 displayed in the THUMB-TAB IMAGES section 50 of the graphical user interface 46 may be determined based on the particular searching method employed, and in the case where the SEQUENTIAL FRAME BY FRAME icon button 72 is selected, based on operator input of image frames numbers using the frame number selection boxes 68,70. The video playback device 22 can be configured to compute all of the frame indices for the selected search algorithm, provided that both the left and right image sub-sequences are selected. With respect to the illustrative graphical user interface 46 of FIG. 3, for example, the selection of the FRAMES AT ONCE icon button 74 may cause the searching algorithm 44 within the video playback device 22 to compute all of the frame indices and then output image frames associated with those indices on the THUMB-TAB IMAGES section 50. For example, using the bifurcation searching algorithm described below with respect to FIG. 5A, the first three iterations of frame indices can be computed to be 0, 125, 250, 375, 500, 625, 750, 875, 1000, 1125, 1250, 1375, 1500, 1625, 1750, 1875, and 2000 for a given 2000 frame image sequence. The operator may then select an image sub-sequence that lies between two thumb-tab image frames 52 for further search, if desired.

A VIDEO FILE SELECTION section 90 of the graphical user interface 46 can be used to select a previously recorded video file to search. A text selection box 92 can be provided to permit the operator to enter the name of a stored video file to search. If, for example, the operator desires to search an image sequence file stored within one of the playback device databases 30,32 entitled “Video Clip One”, the user may enter this text into the text selection box 92 and then click a SELECT button 94, causing the graphical user interface 46 to display the image frames on the VIDEO SEQUENCE VIEWER section 48 along with thumb-tab images of the image sequence within the THUMB-TAB IMAGES section 50.

In some embodiments, a set of DURATION text selection boxes 96,98 can be provided to permit the operator to enter a duration in which to search the selected video file, allowing the operator to view an image sub-sequence of the entire video file. In some cases, the duration of each image sub-sequence can be chosen so that the operator will not lose interest in viewing the contents of the image sub-sequence. If, at a later time the operator desires to re-select those portions of the video file that were initially excluded, the graphical user interface 46 can be configured to later permit the operator to re-select and thus re-tune the presentation procedure to avoid missing any sequences.

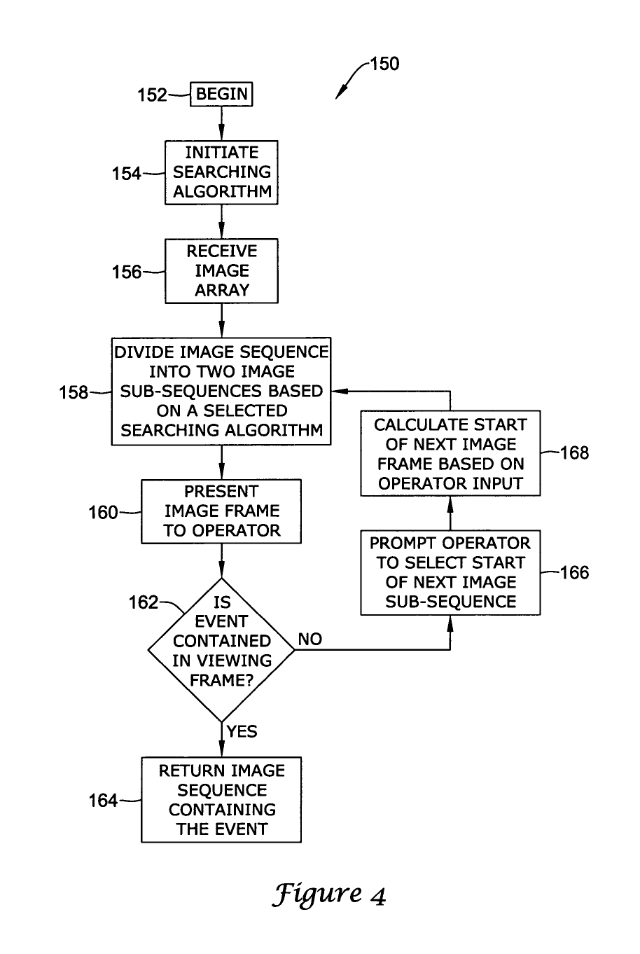

FIG. 4 is a flow chart showing an illustrative method 150 for presenting an image sequence to an operator using the video playback device 22 of FIG. 2. The illustrative method 150 may begin at block 152 with the initiation of a searching algorithm 154 within the video playback device 22. Initiation of the searching algorithm 154 may occur, for example, by a command received via the user interface 24, or from a command received by some other component within the system (e.g. a host video application software program). With respect to the illustrative graphical user interface 46 of FIG. 3, initiation of the searching algorithm 154 may occur, for example, when the SEQUENTIAL FRAME BY FRAME icon button 72 is selected on the display screen 47.

Once the searching algorithm 154 is initiated, the video playback device 22 next calls one or more of the image databases 30,32 and receives an image array containing an image sequence 34,36, as indicated generally by reference to block 156. The image array may comprise, for example, an image sequence similar to that described above with respect to FIG. 1, containing an event of interest in one or more consecutive or nonconsecutive image frames.

Upon receiving the image array at step 156, the video playback device 22 can then be configured to sequentially divide the image sequence into two image sub-sequences based on a searching algorithm selected by the operator, as indicated generally by reference to block 158. Once the image sequence is divided into two image sub-sequences, the video playback device 22 can then be configured to present an image frame corresponding to the border of two image sub-sequences, as shown generally by reference to block 160. In those embodiments employing a graphical user interface 46, for example, the video playback device 22 can be configured to present an image frame in the THUMB-TAB IMAGES section 50 at the border of two image sub-sequences. Using the set of playback controls 40 and/or graphical user interface 46, the operator may then scan one of the image sub-sequences to detect the occurrence of an event of interest. If, for example, the operator desires to find a particular event contained within the image sequence, the operator may use a fast-forward and/or reverse-view button on the set of playback controls 40 to scan through the currently displayed image sub-sequence and locate the event. In certain embodiments, the video playback device 22 can be configured to prompt the operator to compare the currently viewed image sub-sequence with the other image sub-sequence obtained at step 158.

If at decision block 162 the operator determines that the event is contained in the currently viewed image sub-sequence, then the operator may prompt the video playback device 22 to return the image sequence containing the event, as indicated generally by reference to block 164. On the other hand, if the operator determines that the desired event is not contained in the currently viewed image sub-sequence, then the video playback device 22 may then prompt the operator to select the start location of the next image subsequence to be viewed, as indicated generally by reference to block 166. If, for example, the operator indicates that the event of interest is contained in those image frames occurring after the currently viewed image sub-sequence, the operator may prompt the video playback device 22 to continue the process of sequentially dividing the image sequence using the right image sub-sequence. Alternatively, if the operator indicates that the event is contained in those image frames occurring before the currently viewed image frame or image sub-sequence, the operator may prompt the video playback device 22 to continue the process of sequentially dividing the image sequence using the left image sub-sequence.

Once input is received from the operator at block 166, the video playback device 22 can then be configured to calculate the start of the next viewing frame, as indicated generally by reference to block 168. The process of sequentially dividing the image array into two image sub-sequences (block 158) and presenting a viewing frame to the operator (block 160) can then be repeated one or more times until the desired event is found.

The steps 158,160 of segmenting the image sequence into two image sub-sequences and presenting an image frame to the operator can be accomplished using a searching algorithm selected by the user. Examples of suitable searching algorithms that can be used may include, but are not limited to, a Bifurcation searching algorithm, a Pseudo-Random searching algorithm, a Golden Section searching algorithm, and a Fibonacci searching algorithm. An example of each of these searching algorithms can be understood by reference to FIGS. 5A-5D. Given an image sequence “I_{ab}” that starts at frame number “a” and ends at frame number “b”, each of these searching algorithms may split the image sequence “I_{ab}” into two image sub-sequences “I_{ac}” and “I_{cb}”. The value of “c” is typically computed by the specific searching algorithm selected, and will usually vary.

FIG. 5A is a schematic view showing an illustrative method of searching an image sequence 170 using a Bifurcation searching algorithm. As shown in FIG. 5A, the illustrative image sequence 170 may begin at frame “F₁”, and continue in ascending order to frame “F₂₀₀₀”, thus representing a image sequence having 2000 image frames.

Using a bifurcation approach, the image sequence 170 is iteratively divided at its midpoint based on the following equation:
c=(b−a)/2; (1)

where:

c is the desired image frame number division location;

a is the starting frame number; and

b is the ending frame number.

A first iteration indicated in FIG. 5A splits the image sequence 170 at “F₁₀₀₀”, forming a left-handed image sub-sequence that spans image frames “F₁” to “F₁₀₀₀” and a right-handed image sub-sequence that spans image frames “F₁₀₀₀” to “F₂₀₀₀”. Once the image sequence 170 is initially split in this manner, the operator may then select whether to view the left or right-handed image sub-sequence for continued searching. If, for example, the operator wishes to search the left-handed image sub-sequence (i.e. “F₁” to “F₁₀₀₀”), the operator may prompt the video playback device 22 to continue to bifurcate the left image sub-sequence in a second iteration “2” at frame “F₅₀₀”. As further shown in FIG. 5A, the selection and bifurcation of image sub-sequences may continue in this manner for one or more additional iterations until a desired event is found, or until the entire image sequence 170 has been viewed. As indicated by iteration numbers “3”, “4”, and “5”, for example, the image sequence 170 can be further divided by the operator at frames “F₁₅₀₀”, “F₁₂₅₀” and then “F₁₁₂₅” to search for an event or events contained in the right-handed image sub-sequence, if desired. While several example iterations are provided in FIG. 5A, it should be understood that the number of iterations as well as the locations selected to segment the image sub-sequences may vary based on input from the operator.

FIG. 5B is a schematic view showing an illustrative method of searching the image sequence 170 using a Pseudo-Random searching algorithm. In a Pseudo-Random approach, the image sequence 170 can be divided based on random numbers. The value of “c” can be determined by a random number generated between the values “a” and “b” based on the following equation:
c=a+(b−a)*Rand; (2)

where:

c is the desired image frame number division location;

a is the starting frame number;

b is the ending frame number; and

*Rand is a uniform random number between 0 and 1.

As can be seen in FIG. 5B, the image sequence 170 is divided into two image sub-sequences during each iteration based on a uniform random number between 0 and 1. A first iteration in FIG. 5B, for example, shows the image sequence 170 divided into two image sub-sequences at frame “F₇₀₀”. Once the image sequence 170 is initially split, the operator may then select whether to view the left or right-handed image sub-sequence for continued viewing. If, for example, the operator wishes to view the left-handed image sub-sequence (i.e. “F₁” to “F₇₀₀”, the user may prompt the video playback device 22 to continue to divide the image sub-sequence in a subsequent iteration, thereby splitting the image sub-sequence further based on the next random number (*Rand) generated. The selection and division of image sub-sequences may continue in this manner for one or more additional iterations producing additional image sub-sequences, as further shown in FIG. 5B.

FIG. 5C is a schematic view showing an illustrative method of searching the image sequence 170 using a Golden Section searching algorithm. In a Golden Section approach, the image sequence 170 can be divided into left and right image sub-sequences based on four image frames “Fₐ”, “F_{b}”, “F_{c}”, and “F_{d}”, where frames “Fₐ” and “F_{b}” represent the first and last image frames within the image sequence. Frames “F_{c}” and “F_{d}”, in turn, may represent those image frames located in between frames “Fₐ” and “F_{b}”, and can be determined based on the following equations:
c=a+r*r*(b−a); (3)
d=a+r*(b−a); and (4)
r=1(\sqrt{5}−1)/2 (5)

where:

c is a first image frame division location;

d is a second image frame division location;

a is the starting frame number;

b is the ending frame number; and

r is a constant.

In the first iteration of searching an image sequence I_{ab}, both c and d will need to be computed. Thereafter, either “c” or “d” will need to be computed. If, during the selection process, the left image sub-sequence “I_{ad}” is selected in subsequent iterations, then the value “b” is assigned the value of “d”, “d” is assigned the value of “c”, and a new value of “c” is computed based on Equation (3) above. Conversely, if the right image sub-sequence “I_{cb}” is selected in subsequent iterations, then the value “a” is assigned the value of “c”, “c” is assigned the value of “d”, and a new value for “d” is computed based on Equation (4) above. The selection and division of image sub-sequences may continue in this manner for one or more additional iterations producing additional image sub-sequences, as further shown in FIG. 5C.

FIG. 5D is a schematic view showing an illustrative method of searching the image sequence 170 using a Fibonacci searching algorithm. The Fibonacci algorithm is similar to that employed by the Golden Search algorithm, except that in the Fibonacci approach the ratio “r” in Equation (4) above is not constant with each iteration, but is instead based on the ratio of two adjacent numbers in a Fibonacci number sequence. A Fibonacci number sequence can be defined generally as those numbers produced based on the following equations:
Γ₀=0,Γ₁=1; and (6)
Γ_{N}=Γ_{N-1}+Γ_{N-2}; for N≧2. (7)

As can be seen from the above equations (6) and (7), the first two Fibonacci numbers Γ₀, Γ₁ within the image sequence can be initially set at values of 0 and 1, respectively. A representation of the first twelve Fibonacci numbers for each corresponding k^{th} iteration is reproduced below in Table 1.

TABLE 1

| | k = | | | | | | | | | | | | |
|---|---|---|---|---|---|---|---|---|---|---|---|---|---|
| | 0 | 1 | 2 | 3 | 4 | 5 | 6 | 7 | 8 | 9 | 10 | 11 | 12 |
| Γₖ = | 0 | 1 | 1 | 2 | 3 | 5 | 8 | 13 | 21 | 34 | 55 | 89 | 144 |

A predetermined value of N may be set in the Fibonacci search algorithm. From this predetermined value N, the value of “r” may be computed based on the following equations:
rₖ=Γ_{N-1-k}/Γ_{N-k}; where Γ_{N} is the N^{th} Fibonacci number. (8)

In addition, the values of “c” and “d” can be computed as follows:
cₖ=aₖ+(1−rₖ)*(bₖ−aₖ); and (9)
dₖ=aₖ+rₖ*(bₖ−aₖ). (10)

By employing image segmentation based on Fibonacci numbers, the length of the image sub-sequences geometrically decreases for each successive k, allowing the operator to quickly scan through the image sequence for an event of interest, and then select only those image sub-sequences believed to contain the event. Such method permits a rapid interval reduction to be obtained during searching, allowing the operator to quickly locate the event within the image sequence. The size Sᵢ of each image sub-sequence produced in this manner can be defined generally by the following equation:

$${S}_{i} = α {\sum }_{k = 1}^{i - 1} {S}_{k} ; \qquad ( 11 )$$

where α is a constant >1.
Thus, for an array containing Γ_{N-1} elements, the length of the image subset is bounded to Γ_{N-1}−1 elements. Based on an image array having a beginning length of Γ_{N-1}, the worst-case performance for determining whether an event lies within the image sequence can thus be determined from the following equation:

$${Γ}_{N} = ( \frac{1}{\sqrt{5}} ) {( \frac{1 + \sqrt{5}}{2} )}^{N} ; \qquad ( 12 )$$

which can be further expressed as follows:
Γ_{N}=c(1.618)^{N}; where c is a constant. (13)

In each of the above searching algorithms of FIGS. 5A-5D, an optimization objective function that is dependent upon calculations based on the sequence imagery may be used to detect and track targets within one or more image frames. For example, in some applications the operator may wish to select an image sub-sequence in which an object of a given type approaches some chosen target (e.g. an entranceway or security gate) within a given Region of Interest (ROI) in the scene. Furthermore, the operator may also wish to have the chosen image sub-sequence contain the event at its midpoint. In such case, the optimization objective function can be chosen as a distance measure between the object and the target within the Region of Interest. In some embodiments, this concept may be extended to permit the operator to choose “pre-target approach” and/or “post-target departure” sequence lengths that can be retained or archived for later use during playback and/or subsequent analysis. Another candidate optimization objective function may be based on the entropy of the image, which can be defined by the following equation:

$${Γ}_{N} = {c ( 1.618 )}^{N} ; \\ {\sum }_{i} {\sum }_{j} {p}_{ij} ln {p}_{ij} ; \qquad ( 14 )$$

where pᵢⱼ is the pixel value at position i,j.

In some embodiments, the search algorithms may be combined with other search techniques such as the searching of stored meta-data information that describes the activity in the scene and is associated to the image sequences. For example, an operator may query the meta-data information to find an image sub-sequence with a high probability of having the kind of image sequence sought. For example, the search algorithm can identify the sequence segments that contain red cars from the meta-data information. The Bifurcation, Pseudo-Random, Golden Search, and/or Fibonacci searching algorithms may then be applied only to that portion of the image sequence having the high probability.

While several searching algorithms are depicted in FIGS. 5A through 5D, it should be understood that other sequential searching algorithms could be employed, if desired. In one alternative embodiment, for example, a Lattice search may be employed, which similar to other searching algorithms described herein, can be used to sequentially present video images to an operator to detect the occurrence of an event of interest. Other sequential searching techniques, including variations of the Fibonacci and Golden Search algorithms, are also possible.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes can be made with respect to various elements described herein without exceeding the scope of the invention.

What is claimed is:

1. A video playback system, comprising:
a video playback device adapted to run a sequential searching algorithm for sequentially presenting video images to an operator; and
a means for interacting with the video playback device.

2. The video playback system of claim 1, wherein said means for interacting with the video playback device includes a user interface.

3. The video playback system of claim 2, wherein the user interface includes a set of playback controls.

4. The video playback system of claim 2, wherein the user interface includes a monitor.

5. The video playback system of claim 2, wherein the user interface is a graphical user interface.

6. The video playback system of claim 1, wherein the video playback device includes a processor unit, a memory unit, and at least one image database adapted to store an image sequence.

7. The video playback system of claim 1, wherein the video playback device includes a decoder.

8. The video playback system of claim 1, wherein the sequential searching algorithm is a Bifurcation searching algorithm.

9. The video playback system of claim 1, wherein the sequential searching algorithm is a Pseudo-Random searching algorithm.

10. The video playback system of claim 1, wherein the sequential searching algorithm is a Golden Section searching algorithm.

11. The video playback system of claim 1, wherein the sequential searching algorithm is a Fibonacci searching algorithm.

12. A video playback device, comprising:
at least one image database containing an image sequence;
a memory unit including a sequential searching algorithm; and
a processor unit adapted to sequentially present one or more image sub-sequences to an operator using the sequential searching algorithm.

13. The video playback device of claim 12, further comprising a user interface for interacting with the video playback device.

14. The video playback device of claim 13, wherein the user interface is a graphical user interface.

15. The video playback device of claim 12, wherein the sequential searching algorithm is a Bifurcation searching algorithm.

16. The video playback device of claim 12, wherein the sequential searching algorithm is a Pseudo-Random searching algorithm.

17. The video playback device of claim 12, wherein the sequential searching algorithm is a Golden Section searching algorithm.

18. The video playback device of claim 12, wherein the sequential searching algorithm is a Fibonacci searching algorithm.

19. A method of searching for an event of interest contained within an image sequence, comprising the steps of:
providing a video playback device adapted to run a sequential searching algorithm;
initiating the sequential searching algorithm within the video playback device;
sequentially dividing the image sequence into a number of image sub-sequences; and
viewing at least one image sub-sequence to determine whether an event of interest is contained therein.

20. The method of claim 19, further comprising the steps of:
prompting an operator to select whether the event of interest is contained within the viewed image sub-sequence;
calculating a start location of the next viewing image sub-sequence based on input received from the operator; and
outputting an image sub-sequence based on the calculated start location.
